(19) United States
(12) Patent Application Publication
(10) Pub. No.: US 2026/0209592 A1
(43) Pub. Date: Jul. 23, 2026

(54) TEMPERATURE-RESISTANT THIXOTROPIC AGENT, AND PREPARATION METHOD AND USE THEREOF

(71) Applicants: QINGDAO UNIVERSITY OF TECHNOLOGY, Qingdao City (CN); CHINA UNIVERSITY OF PETROLEUM (EAST CHINA), Qingdao City (CN)

(72) Inventors: Chang LU, Qingdao City (CN); Yuhuan BU, Qingdao City (CN); Mengran XU, Qingdao City (CN); Shenglai GUO, Qingdao City (CN); Huajie LIU, Qingdao City (CN); Xueyu PANG, Qingdao City (CN)

(21) Appl. No.: 19/464,499

(22) Filed: Jan. 29, 2026

Related U.S. Application Data
(63) Continuation of application No. PCT/CN2025/143175, filed on Dec. 17, 2025.

(30) Foreign Application Priority Data
Jan. 20, 2025 (CN) 2025100841240

(51) Int. Cl. C09K 8/24

(52) U.S. Cl. CPC C09K 8/24

(57) ABSTRACT

The present disclosure relates to a temperature-resistant thixotropic agent, and a preparation method and use thereof. The present disclosure subjects diutan gum to graft modification using acrylic acid and N-vinylpyrrolidone to obtain modified diutan gum; the modified diutan gum is compounded with magnesium aluminum silicate to prepare the temperature-resistant thixotropic agent. The temperature-resistant thixotropic agent prepared according to the present disclosure can significantly enhance the thixotropic properties of magnesium oxychloride cement (MOC) under the high-temperature conditions encountered in oil and gas wells, effectively improve the rheological properties of the cement slurry, enhance the retention capacity of the cement slurry within fractures, and improve the plugging stability, among other improvements. This agent demonstrates broad application prospects in oil and gas well engineering and constitutes an effective solution to the challenge of lost circulation in fractured formations during oil and gas well drilling.

### CROSS-REFERENCE TO RELATED APPLICATIONS

This application is a continuation of International Application No. PCT/CN2025/143175, filed on Dec. 17, 2025, which claims priority to Chinese Patent Application No. 202510084124.0, filed on Jan. 20, 2025. All of the aforementioned applications are incorporated herein by reference in their entireties.

### TECHNICAL FIELD

The present disclosure relates to the technical field of oil and gas well development, and specifically relates to a temperature-resistant thixotropic agent, and a preparation method and use thereof.

### BACKGROUND

During oil and gas well drilling operations, lost circulation poses an increasingly significant challenge, particularly in fractured formations. Due to numerous natural and induced fractures, large loss channels, and high loss rates, lost circulation control operations are difficult. Traditional lost circulation materials, such as bridging materials like walnut shells and rubber, as well as conventional lost circulation cement slurries, all have significant drawbacks. Bridging materials struggle to self-adapt to fracture apertures, resulting in low control efficiency and potential damage to the reservoir. Although conventional lost circulation cement slurries can withstand high pressure, they cause significant reservoir damage and have poor acid solubility, leading to slow post-operation recovery of reservoir flow capacity.

Magnesium oxychloride cement (MOC) offers certain advantages for reservoir lost circulation control due to its fast setting and good acid solubility. However, for controlling lost circulation in fractured reservoirs, the issue of MOC retention within fractures must be addressed, necessitating that the MOC possesses strong thixotropy. Furthermore, as oil and gas exploration and development extend into deeper strata, high temperature has also become a major challenge in drilling lost circulation control. Currently, there is limited research on thixotropic agents suitable for high-temperature oil and gas well conditions, and most are only applicable to silicate-based cements. Research on thixotropic agents suitable for MOC is even scarcer.

### SUMMARY

In view of the aforementioned problems, the present disclosure provides a temperature-resistant thixotropic agent, and a preparation method and use thereof. The temperature-resistant thixotropic agent prepared according to the present disclosure can significantly enhance the thixotropic properties of MOC under the high-temperature conditions encountered in oil and gas wells.

The temperature-resistant thixotropic agent according to the present disclosure is prepared by compounding modified diutan gum with magnesium aluminum silicate. The modified diutan gum is prepared by subjecting diutan gum to graft modification using acrylic acid and N-vinylpyrrolidone.

A method of preparing a temperature-resistant thixotropic agent includes the steps of:
(1) Mixing diutan gum and deionized water and stirring until the diutan gum is completely dissolved to obtain a solution I.

In this step, high-speed stirring is performed at a rotational speed ranging from 1000 rpm to 2000 rpm until the diutan gum is completely dissolved, forming a uniform solution system. This ensures uniform dispersion of the starting materials for the subsequent reaction, providing favorable foundational conditions for the graft modification reaction.
(2) Neutralizing acrylic acid to a neutralization degree of 80% to 85%, adding N-vinylpyrrolidone and an initiator thereto, and stirring to dissolve to obtain a solution II.

In this step, 17-19 parts by mass of acrylic acid are neutralized to a neutralization degree of 80% to 85% using a sodium hydroxide solution with a concentration of 5 mol/L. The neutralization process requires strict control of reaction conditions to ensure the accuracy and stability of the neutralization reaction. After the reaction mixture cools to room temperature, 1-3 parts by mass of N-vinylpyrrolidone and 0.10-0.12 parts by mass of an initiator are added thereto. The initiator is one or more selected from potassium persulfate, ammonium persulfate, and sodium persulfate. After thorough stirring and dissolution, solution II is obtained.
(3) Dropwise adding the solution II to the solution I, after completion of the dropwise addition, raising the temperature to 65° C. to 75° C., maintaining the temperature with stirring for reaction, and after completion of the reaction, performing post-treatment to obtain a modified diutan gum powder.

In this step, the dropwise addition method serves to control the reaction rate, allowing the reaction to proceed more smoothly and avoiding side reactions or uneven product performance due to overly intense reactions. Subsequently, the system temperature is raised to 65° C. to 75° C., and this temperature is maintained with continuous stirring for 3 hours. During this process, a graft polymerization reaction occurs within the system, generating a modified polymer with specific structure and performance, thereby obtaining a crude product.

After the reaction concludes, the crude product is sequentially washed 3 to 5 times with distilled water and an ethanol solution. The distilled water removes water-soluble impurities, and the ethanol solution removes organic impurities, thoroughly purifying the product to ensure the purity and performance stability of the product. Subsequently, the product is dried to constant weight in an environment of 50° C. to 60° C. to remove moisture. The dried sample is then pulverized into a powder. The powder is sieved through a 100-mesh to 300-mesh standard sieve to obtain a modified diutan gum powder with a particle size ranging from 48 μm to 150 μm. A suitable particle size facilitates better uniform mixing with magnesium aluminum silicate in the subsequent compounding process, enabling a synergistic effect.
(4) Uniformly mixing the modified diutan gum powder with magnesium aluminum silicate to obtain the temperature-resistant thixotropic agent.

In this step, the mass ratio of modified diutan gum powder to magnesium aluminum silicate is 1:(1-2). The mixing is performed by passing the mixture through a sieve. Specifically, the modified diutan gum powder and the magnesium aluminum silicate are placed in a 100-mesh sieving device. The sieve mesh undergoes reciprocating vibration via a mechanical device, and the sieving operation is continuously performed 5 to 8 times. This ensures that the modified diutan gum powder and the magnesium aluminum silicate achieve uniform and thorough mixing, thereby obtaining the temperature-resistant thixotropic agent.

In the present disclosure, diutan gum is subjected to graft modification using acrylic acid and N-vinylpyrrolidone to enhance the temperature and salt resistance of the diutan gum. The carboxyl groups of acrylic acid interact with components of the MOC, improving compatibility and stability, forming hydrogen bonds and cross-linked structures, which enhance temperature resistance and colloidal strength, preventing deterioration of the cement slurry at high temperatures. N-vinylpyrrolidone possesses good thermal stability. The five-membered ring structure of N-vinylpyrrolidone can improve the temperature and salt resistance of the graft copolymer. Furthermore, its polar groups can cooperate with acrylic acid and diutan gum to construct a complex three-dimensional network structure, enhancing the thixotropic properties and temperature resistance of the MOC. Magnesium aluminum silicate, by virtue of its unique layered crystal structure and large specific surface area, on one hand, can further optimize the dispersion state of the modified diutan gum in the cement slurry matrix, enhancing the stability of the system. On the other hand, its own good adsorption properties can synergize with the modified diutan gum to better adhere to fracture surfaces, forming a more stable and dense plugging structure. This significantly improves the overall efficacy of the system in lost circulation control operations for fractured reservoirs, ensuring the smooth progress of such operations, thereby contributing significantly to the safe and efficient extraction of oil and gas wells.

The thixotropic agent obtained according to the present disclosure can be used in drilling fluid loss control agents and used in combination with MOC to achieve stable plugging.

Compared with the prior art, the present disclosure provides the following beneficial effects.

The thixotropic agent according to the present disclosure exhibits good solubility and temperature and salt resistance, effectively enhancing the thixotropy of the cement slurry. The thixotropic agent demonstrates good compatibility with MOC, operates stably in the high-temperature environment of oil and gas wells, enhances the retention capacity of the lost circulation cement slurry within fractures, and forms a stable plug. Furthermore, the preparation method is simple, efficient, and uses readily available raw materials, showing good prospects for industrial production and promotion. The thixotropic agent is expected to efficiently solve the problem of lost circulation in fractured reservoirs of oil and gas wells and promote the development of oil and gas extraction technology.

### BRIEF DESCRIPTION OF THE DRAWINGS

FIG. 1 shows an infrared spectroscopy analysis of the modified diutan gum.

FIG. 2 shows the thermogravimetric analysis (TGA) curve of the modified diutan gum.

### DETAILED DESCRIPTION OF THE EMBODIMENTS

To clarify the technical advantages of the present disclosure, the embodiments of the present disclosure are further described in detail below with reference to specific examples and the accompanying drawings.

### Comparative Example 1

Diutan gum alone was used as the thixotropic agent.

### Comparative Example 2

Magnesium aluminum silicate alone was used as the thixotropic agent.

### Comparative Example 3

Commercially available bentonite alone was used as the thixotropic agent.

### Example 1

A method of preparing a temperature-resistant thixotropic agent includes the steps of:

3 g of diutan gum and 150 ml of water were added to a three-necked flask equipped with a stirring device. The mixture was stirred at high speed until the diutan gum was completely dissolved to obtain Solution I.

18.18 g of acrylic acid was neutralized using a 5 mol/L sodium hydroxide (NaOH) solution to a neutralization degree of 82%. After the reaction mixture cooled to room temperature, 1.82 g of N-vinylpyrrolidone and 0.115 g of potassium persulfate were added thereto, and the mixture was stirred to dissolve, obtaining Solution II.

Solution II was slowly and uniformly added dropwise to Solution I using a constant-pressure dropping funnel. After the dropwise addition was completed, the temperature was raised to 69° C. This temperature was maintained with continuous stirring for 3 hours, thereby obtaining a crude product. After the reaction concluded, the crude product was sequentially washed three times with sufficient amounts of distilled water and an ethanol solution to thoroughly remove impurities. Finally, the product was dried to constant weight at 60° C., pulverized into a powder, and sieved through a 100-mesh standard sieve, obtaining a modified diutan gum powder meeting the particle size requirement. This powder was designated as DG-1.

10 g of DG-1 and 10 g of magnesium aluminum silicate powder were placed into a plastic zipper bag. The powders were preliminarily mixed uniformly by manual shaking. The preliminarily mixed powder was transferred to a sieve shaker, and the sieving operation was continuously performed 5 times to achieve uniform and thorough mixing, obtaining the finished temperature-resistant thixotropic agent, designated as T-1.

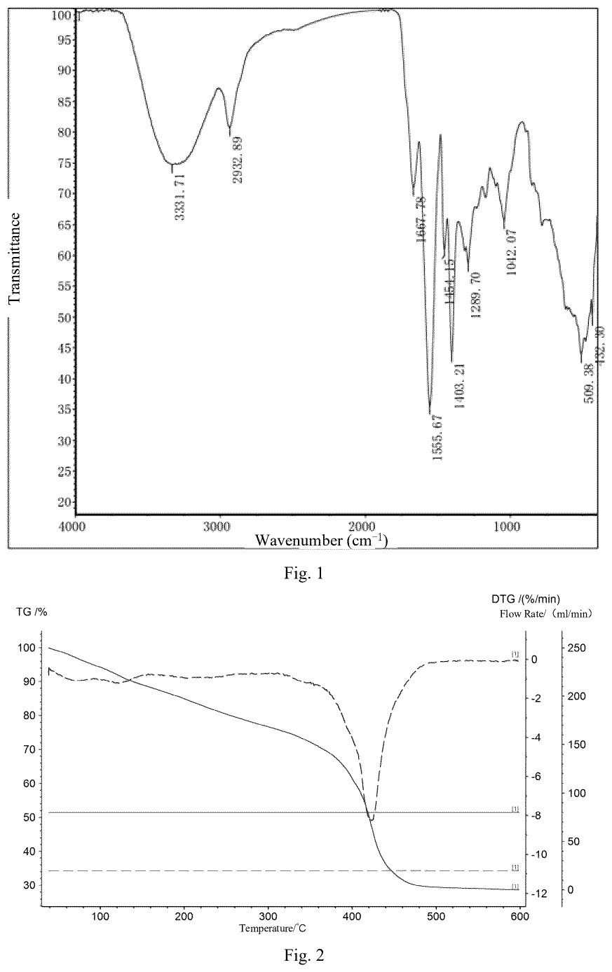

A portion of DG-1 was subjected to Fourier-transform infrared (FTIR) spectroscopy, yielding the spectrum shown in FIG. 1. The results indicated successful grafting of the monomers onto the diutan gum branches. Specifically, from the infrared spectrum of the product, it can be seen that the absorption peak at 3331.71 cm⁻¹ is attributed to the O—H stretching vibration; the absorption peak at 2932.89 cm⁻¹ is attributed to the asymmetric C—H stretching vibration; the absorption peak at 1667.78 cm⁻¹ is attributed to the carbonyl C═O stretching vibration; the absorption peak at 1454.15 cm⁻¹ is attributed to the —CH₂-bending vibration; the absorption peak at 1403.21 cm⁻¹ is attributed to the amide C—N stretching vibration from N-vinylpyrrolidone, which is a characteristic absorption peak of the lactam structure in N-vinylpyrrolidone; the absorption peak at 1289.70 cm⁻¹ is attributed to the C—O—C stretching vibration, indicating successful grafting of the monomers onto the diutan gum; the absorption peak at 1042.07 cm⁻¹ is attributed to the C—O stretching vibration. Furthermore, no N—H bending vibration absorption peak was observed in the 1650-1590 cm⁻¹ range in the infrared spectrum, indicating that the vinyl group in N-vinylpyrrolidone underwent addition polymerization and did not undergo a ring-opening reaction. In summary, the monomers acrylic acid and N-vinylpyrrolidone were successfully grafted onto the diutan gum.

A portion of DG-1 was subjected to TGA to obtain the TGA curve shown in FIG. 2. The results indicate good temperature resistance of the modified diutan gum. Specifically, the modified diutan gum exhibited significant mass loss after 400° C. The thermogravimetric weight loss primarily occurred in two stages. The first stage mainly involved endothermic evaporation of free water and bound water in the molecules. The second stage mainly involved breakage and decomposition of the polysaccharide backbone and side chains of the modified diutan gum, as well as thermal decomposition of the grafted groups.

### Example 2

The operational steps were substantially the same as the preparation process for the modified diutan gum powder in Example 1, with the following differences: 17.4 g of acrylic acid was neutralized to a neutralization degree of 85%; 2.6 g of N-vinylpyrrolidone was added; the reaction temperature was controlled at 75° C. The final product was a modified diutan gum powder designated as DG-2, which was set aside.

According to a weight ratio of 1:1.5, 10 g of DG-2 and 15 g of magnesium aluminum silicate powder were weighed. Mixing was performed using the same sieving and mixing method as employed in the preparation of the temperature-resistant thixotropic agent in Example 1, obtaining the finished temperature-resistant thixotropic agent designated as T-2.

### Example 3

The operational steps were substantially the same as the preparation process for the modified diutan gum powder in Example 1, with the following differences: 19 g of acrylic acid was neutralized to a neutralization degree of 80%; 1 g of N-vinylpyrrolidone was added; the reaction temperature was controlled at 70° C. The final product was a modified diutan gum powder designated as DG-3, which was set aside.

According to a weight ratio of 1:2, 10 g of DG-3 and 20 g of magnesium aluminum silicate powder were weighed. Mixing was performed using the same sieving and mixing method as employed in the preparation of the temperature-resistant thixotropic agent in Example 1, obtaining the finished temperature-resistant thixotropic agent designated as T-3.

### Test Example 1

Test Example 1 was used to evaluate the application effects in MOC of the thixotropic agents provided in Comparative Examples 1-3 and the temperature-resistant thixotropic agents prepared in Examples 1-3. The specific operations were as follows:

A cement slurry was prepared according to the method specified in GB/T 19139-2012 “Preparation of oil well cement slurries”: 335 parts of light-burned magnesia, 243 parts of magnesium chloride hexahydrate, 173 parts of water, 10 parts of retarder. To the base cement slurry, 1.625 parts of the thixotropic agent from Comparative Example 1 was added, preparing cement slurry C1. To the base cement slurry, 6.5 parts each of the thixotropic agents from Comparative Example 2 and Comparative Example 3 were added, preparing cement slurries C2 and C3, respectively. To the base cement slurry, 6.5 parts each of the temperature-resistant thixotropic agents prepared in Examples 1-3 were added, preparing cement slurries C4-C6.

The thixotropic properties of the cement slurries were characterized by the increase in consistency measured after stopping and restarting a consistometer, with a larger increase correlating to better thixotropy. The cement slurries C1-C6 were tested at 90° C. using this consistency increase method. The measurement results are shown in Table 1 below.

TABLE 1
Thixotropic Properties of Magnesium Oxychloride Cement
Slurries Containing Thixotropic Agents at 90° C.

| | | Consistency Increase After | | | |
|---|---|---|---|---|---|
| | | Stopping & Restarting | | | |
| | Initial | Consistometer/Bc | | | |
| | Consistency/ | 10 min | 20 min | 30 min | Thixotropy |
| Sample | Bc | stop | stop | stop | Grade |
| Base | 8 | 12 | 13 | 15 | Poor |
| Cement | | | | | |
| Slurry | | | | | |
| C1 | 35 | 38 | 55 | 67 | Excellent |
| C2 | 8 | 20 | 25 | 29 | Fair |
| C3 | 10 | 6 | 14 | 22 | Fair |
| C4 | 17 | 28 | 37 | 44 | Good |
| C5 | 16 | 25 | 33 | 40 | Good |
| C6 | 17 | 27 | 36 | 42 | Good |

As can be seen from the data in Table 1, although the thixotropic agent provided in Comparative Example 1 significantly enhanced the thixotropy of the cement slurry, its thickening ability was excessive, causing the initial consistency of the cement slurry to exceed 30 Bc, which is unfavorable for pumping. Furthermore, the thixotropic agent of Comparative Example 1 is relatively high in cost, making it economically unfavorable. The thixotropic agents provided in Comparative Examples 2 and 3 had limited application effects in MOC, resulting in only fair cement slurry thixotropy.

In contrast, the temperature-resistant thixotropic agents prepared in the examples of the present disclosure not only enhanced the thixotropic properties of the cement slurry to a good grade but also allowed the initial consistency of the cement slurry to meet construction requirements. This demonstrates that the temperature-resistant thixotropic agent of the present disclosure has better application effects in MOC.

### Test Example 2

Test Example 2 was used to evaluate the solubility of the thixotropic agent from Comparative Example 1 and the temperature-resistant thixotropic agents prepared in Examples 1-3. The specific operations were as follows:

2 g of sample and 100 mL of deionized water were weighed and placed into a 200 ml beaker. The beaker was placed on a magnetic stirrer, and the stirring speed was set to 300 rpm. The time required for the sample to dissolve completely was recorded. The test results are shown in Table 2 below.

TABLE 2
Dissolution Time of Various Thixotropic Agent Samples

| Sample | Dissolution Time/min |
|---|---|
| Comparative Example 1 | Did not dissolve within 240 min; |
| | agglomeration occurred |
| Example 1 | 14 min |
| Example 2 | 17 min |
| Example 3 | 15 min |

As can be seen from the data in Table 2, the thixotropic agent in Comparative Example 1 exhibited extremely poor solubility, failing to dissolve completely and even undergoing agglomeration after 240 minutes of stirring. This indicates poor affinity of this thixotropic agent with water, making it difficult to disperse uniformly in solution.

In contrast, the dissolution times for the temperature-resistant thixotropic agents prepared in Examples 1-3 ranged from 14 to 17 minutes, indicating relatively thorough dissolution and uniform dispersion within a reasonable time frame. This demonstrates that the temperature-resistant thixotropic agent prepared according to the present disclosure, while ensuring good compatibility with MOC, also offers relatively good solubility, thereby allowing it to stably exert its advantages of enhancing cement slurry thixotropy and improving retention capacity within fractures in practical applications.

In summary, the thixotropic agent prepared by the method of preparing the temperature-resistant thixotropic agent for MOC provided in the examples of the present disclosure exhibits good solubility and temperature resistance. This thixotropic agent effectively addresses the multiple requirements for thixotropic agents during lost circulation control in fractured formations in oil and gas well drilling processes, demonstrating the innovation and practical utility of the present disclosure in the development of thixotropic agents for MOC.

Although embodiments of the present disclosure have been shown and described, those skilled in the art can understand that various changes, modifications, substitutions, and alterations can be made to these embodiments without departing from the principle and spirit of the present disclosure. The scope of the present disclosure is defined by the appended claims and their equivalents.

What is claimed is:

1. A method of preparing a temperature-resistant thixotropic agent, wherein diutan gum is graft-modified using acrylic acid and N-vinylpyrrolidone to obtain modified diutan gum; and the modified diutan gum is compounded with magnesium aluminum silicate to prepare the temperature-resistant thixotropic agent; and
wherein diutan gum, acrylic acid, and N-vinylpyrrolidone are in a mass ratio of (2-4):(17-19):(1-3); and wherein the modified diutan gum powder and magnesium aluminum silicate are in a mass ratio of 1:(1-2).

2. The method of preparing the temperature-resistant thixotropic agent according to claim 1, wherein the method comprises the steps of:
(1) mixing diutan gum and deionized water and stirring until the diutan gum is completely dissolved to obtain a solution I;
(2) neutralizing acrylic acid to a neutralization degree of 80% to 85%, adding N-vinylpyrrolidone and an initiator thereto, and stirring to dissolve to obtain a solution II;
(3) dropwise adding the solution II to the solution I, after completion of the dropwise addition, raising the temperature to 65° C. to 75° C., maintaining the temperature with stirring for reaction, and after completion of the reaction, performing post-treatment to obtain a modified diutan gum powder; and
(4) uniformly mixing the modified diutan gum powder with magnesium aluminum silicate to obtain the temperature-resistant thixotropic agent.

3. The method of preparing the temperature-resistant thixotropic agent according to claim 2, wherein diutan gum, deionized water, and initiator are in a mass ratio of (2-4):(150-200):(0.10-0.12).

4. The method of preparing the temperature-resistant thixotropic agent according to claim 2, wherein in step (1), the stirring speed is in the range of 1000 rpm to 2000 rpm.

5. The method of preparing the temperature-resistant thixotropic agent according to claim 2, wherein in step (2), the acrylic acid is neutralized using a sodium hydroxide solution with a concentration of 5 mol/L.

6. The method of preparing the temperature-resistant thixotropic agent according to claim 2, wherein in step (3), the reaction time is 3 h.

7. The method of preparing the temperature-resistant thixotropic agent according to claim 2, wherein in step (3), the modified diutan gum powder has a particle size in the range of 48 μm to 150 μm.

8. The method of preparing the temperature-resistant thixotropic agent according to claim 2, wherein in step (4), the mixing is performed by passing the mixture through a sieve.

9. A temperature-resistant thixotropic agent, wherein the temperature-resistant thixotropic agent is prepared by the method according to claim 1.

10. Use of the temperature-resistant thixotropic agent according to claim 9 for controlling lost circulation in drilling.
